(19) United States
(12) Patent Application Publication
(10) Pub. No.: US 2019/0137036 A1
(43) Pub. Date: May 9, 2019

(54) THERMAL BRIDGE-FREE ASSEMBLY

(71) Applicant: Hutchinson, Paris (FR)

(72) Inventors: Fabrice Chopard, Saint-Martin-d'Hères (FR); Boris Chauvet, Ferrières (FR); Cédric Huillet, Montargis (FR)

(73) Assignee: Hutchinson, Paris (FR)

(21) Appl. No.: 16/308,387

(22) PCT Filed: Jun. 9, 2017
(86) PCT No.: PCT/FR2017/051484

§ 371 Date: Dec. 7, 2018

(30) Foreign Application Priority Data
Jun. 10, 2016 (FR) 1655389

(51) Int. Cl. F17C 3/02

(52) U.S. Cl. CPC F17C 3/027; F17C 2201/0157; F17C 2201/052; F17C 2203/035; F17C 2203/0358; F17C 2270/0107; F17C 2221/033; F17C 2221/035; F17C 2223/0161; F17C 2260/033; F17C 2203/0391

(57) ABSTRACT

This concerns a thermal insulation system interposed between a first volume and a second volume to be thermally managed relative to the first volume, the system comprising a series of parts providing thermal bridges between them and which are: arranged on several layers along a thickness and direction passing through the first and second volumes; and/or, transversely to these directions and thicknesses, offset two by two transversely from one said layer to the adjacent layer; and/or engaged at least two by two, transversely to the direction and thickness to force a heat flow generally provided in the direction, along the thermal bridges, to change direction towards an isotherm.

The present invention relates to the field of thermal management.

In particular, this relates to a thermal insulation part and a thermal insulation system interposed between a first volume and a second volume to be thermally managed relative to the first volume, with the system comprising a series of the above-mentioned parts assembled or arranged like elementary bricks.

In the state-of-the-art, thermally insulating parts under controlled atmosphere (in particular vacuum insulated parts; VIP for vacuum insulated panel) are known.

VIP or VIP structure (vacuum insulating panel; VIP) refers in this text to a structure wherein an envelope is under “controlled atmosphere”, i.e. either filled with a gas with a thermal conductivity lower than that of the ambient air (26 mW/m.K), or under a pressure lower than 10⁵ Pa. A pressure between 10⁻² Pa and 10⁴ Pa inside the envelope may be particularly suitable.

US 2003/0021934 provides a thermal insulation system comprising a series of thermal insulation parts which, at least in some cases, provide thermal bridges between them and which are:
arranged in several layers according to a thickness that each part has and which varies according to a length that said part has, transversely to said thickness, and along which each said part include, externally at least one protrusion adjacent to a depression,
offset and interlocked two by two transversely, from one said layer to an adjacent layer of said layers, so that one said part protrusion of one said layer is engaged in one said part depression of the adjacent layer, thereby forcing a heat flow, generally provided according to the thickness, along the thermal bridges, to change direction towards an isotherm and then to be blocked by a local orientation substantially in an opposite direction.

However, there is still a problem with the effectiveness of these parts and systems of the above-mentioned type that they make it possible, or could make it possible, to produce.

As a matter of fact, when such systems are installed, thermal bridges issues between parts continue to arise.

However, this can be very detrimental to the thermal conductivity of these systems, for example when a system of such parts is interposed between a first volume (which can be the external atmosphere) and a second volume to be thermally managed relative to the first volume, with temperature differences between the volumes that can be greater than 50° C. or even 100° C.

Not sufficiently managing these thermal bridge issues can lead to incomplete thermal management between the volumes.

In addition, a problem arises as to how to build large insulating structures or large insulating volumes.

When thermal insulation must be provided at low temperatures (below −100 or even −150° C., when air gases liquefy), it may also be desirable to avoid local cold spots that would cause certain parts to frost, at least on one side of the insulating walls (particularly outside).

A solution defined here provides that the thermal insulation system presented above should also be such:
said system is interposed between a first volume (7) and a second volume (9) to be thermally managed relative to the first volume,
said layers (13a,13b,13c) are arranged in a direction (D) passing through the first and second volumes, with the thicknesses and length(s) being defined respectively in said direction and transversely thereto,
on at least a first (13b) of the layers (13a, 13b, 13c), at longitudinal ends of two adjacent and successive parts (1, 10, 16) of the layer where said two parts each have one said protrusion, said thermal bridges between said two parts of the first layer (13b) are provided:
   throughout the thickness of the protrusions (21), and,
      facing, on a second, adjacent, layer (13a, 13c), in the thickness wise direction, of an intermediate longitudinal portion of one said depression (23) of one said part which is offset transversely with respect to said two longitudinally, adjacent and successive parts of the first layer (13b). Thus, this thermal insulation system:
will not only be made of a series of elementary bricks, each of which is thermally insulating, assembled, ensuring ease of assembling and appreciable modularity to produce various shapes,
but it will significantly limit the amount of flow reaching this opposite edge.

FIG. 24 and the related explanation below provide details regarding a “change of direction to an isotherm”.

And to further promote both modularity and the fight against thermal losses, it is also proposed:—that a protrusion of said part of a layer should be engaged in one said depression of a single said part of the adjacent layer,
and/or that at the longitudinal ends of two adjacent and successive parts of a layer, said adjacent protrusions of these two parts are engaged together in one said depression of a single said part of the adjacent layer.

With this (these) engagement (s) in a single depression of a single part of said adjacent layer, the passage of the flows to be controlled will be blocked in an optimized way.

Favourably, in order to limit the volumes or thicknesses of insulation and/or increase the internal space available in the thermally managed part, or even limit the weight of the installation created, it is proposed that said insulating parts or bricks should individually have a VIP structure.

And, to promote modularity, with parts that are thus easy to handle while still performing well as regards thermal management, it was recommended that, in said changed direction (direction 100 FIG. 24) or blocking of the created flow, a part should transversely cover an adjacent part over a distance (R) of 500 mm or less, and/or that the elementary surface area of each said part should be 2.5 m² or less.

To create changes in the direction of a thermal flow to an isotherm, it is proposed that at least some of said parts or bricks comprise an envelope and at least one thermal insulation element that the envelope surrounds at least locally, with the envelope and the thermal insulation element each having several successive bends on the outside defining protrusions adjacent to depressions.

These bent shapes will necessarily force said heat flows to oblique several times.

To promote an orientation of said isotherm transverse to directions D and e, the “change of direction” will a priori be carried out at right angles or at least lead to a reorientation perpendicular to these directions D and e (direction 100 in FIG. 24).

As regards these changes of direction, at least the envelope of the part will have at least one T-, or Π- or H- or I-r shaped section, in a direction, a combination of several of these sections or a repetition of at least one of them.

In order to take into account heat losses in the corners, or at the end of the insulated part, it is also proposed that said series of parts define a panel having a section which will have, on at least two sides, protruding (or depressed) parts of certain said engaged parts each with a matching grooved (or protruding) shape of an end block comprising at least one thermal insulation element. The blind grooves of the blocks will form dead ends for the paths of the thermal bridges.

### BACKGROUND OF THE INVENTION

If necessary, the invention will be better understood and other characteristics, details and advantages thereof will become apparent upon reading the following description as a non-exhaustive example with reference to the appended drawings in which:

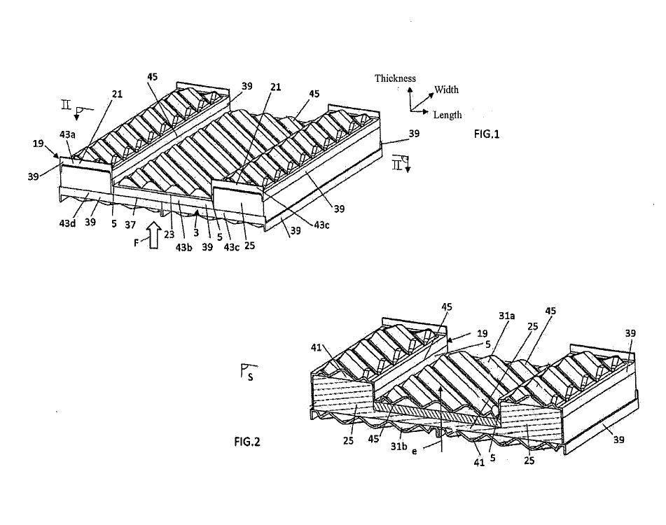

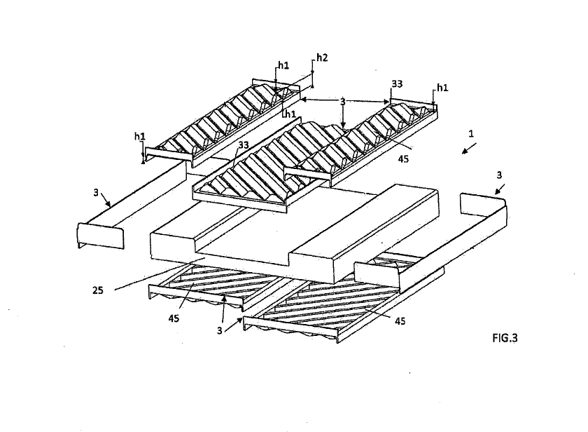

FIG. 1 is a diagram of the part in conformity with the invention, FIG. 2 is the section according to plane II-II,

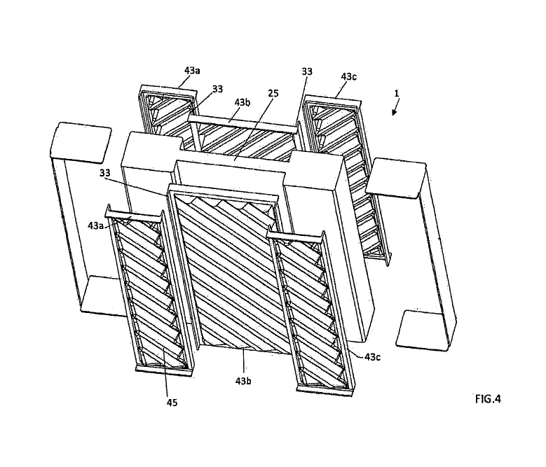

FIG. 3 shows an exploded view, prior to assembling, of the embodiment of FIGS. 1, 2, containing exclusively thermal insulation,

FIG. 4 is a similar view of an alternative solution prior to assembling;

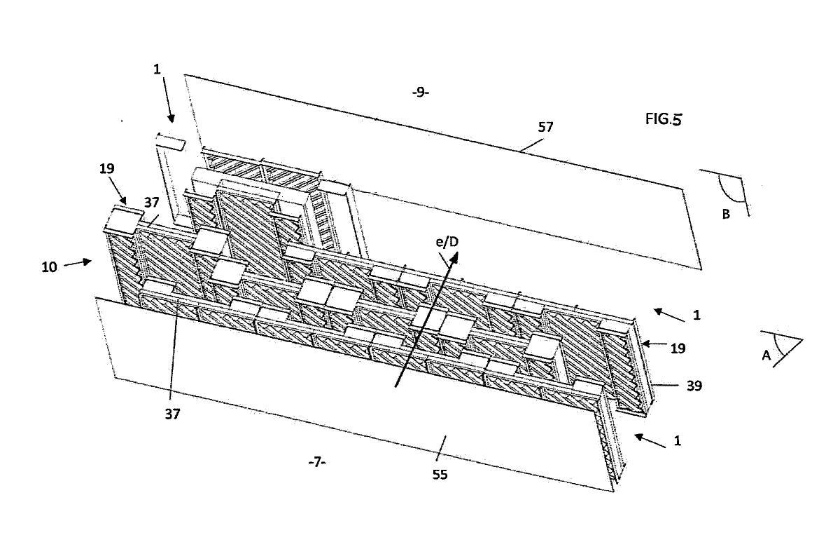

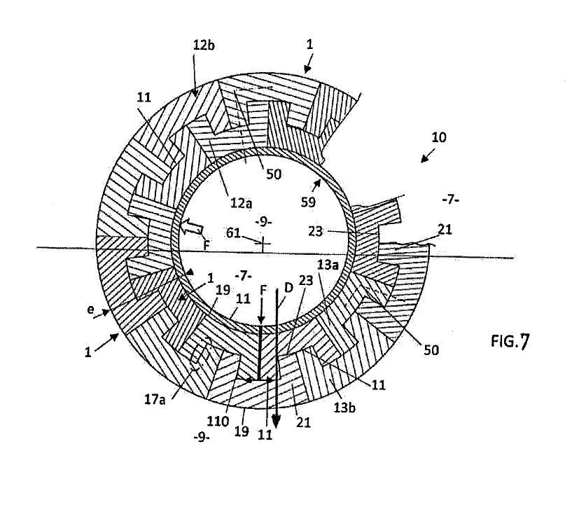

FIG. 5 shows in perspective a partial system of parts as in FIGS. 1, 2, 3, in two successive states, as well as FIG. 7,

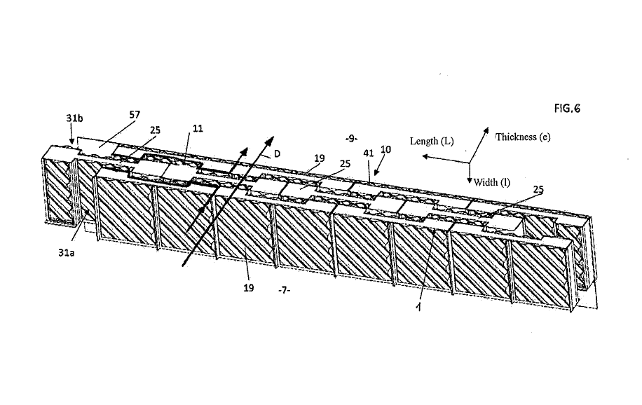

FIG. 6 schematically shows an alternative embodiment of such system:

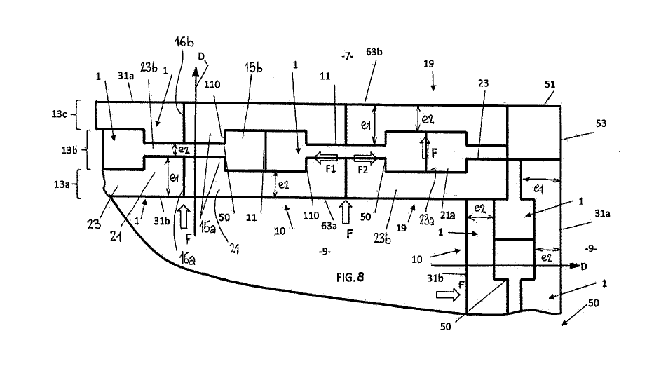

FIGS. 8, 9 show two horizontal sections of insulating housings built with systems of parts of the above types,

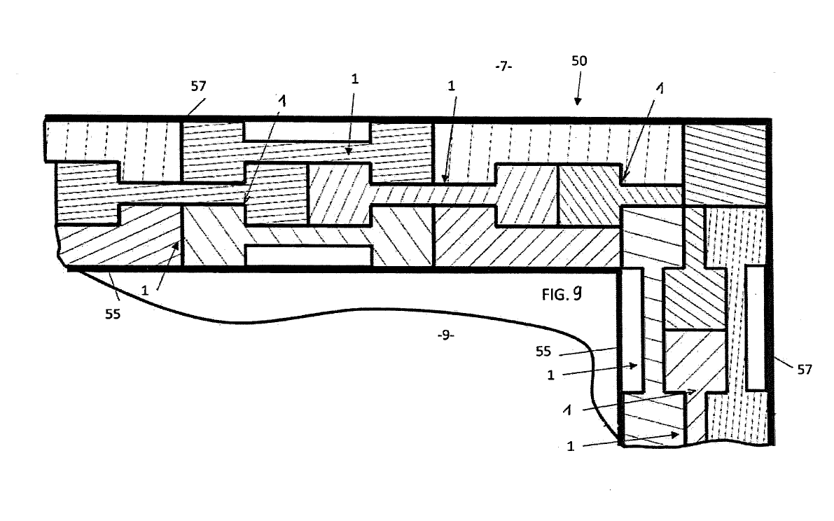

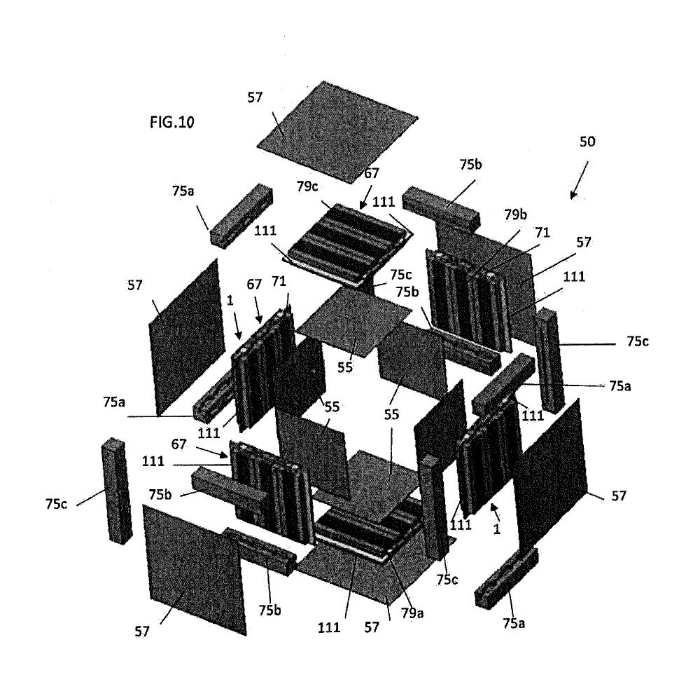

FIG. 10 is an exploded view of a housing built with parts that comply with the invention,

FIG. 11 shows a panel of such housing made of such assembled parts,

FIGS. 12,13,14, schematically show three types of end blocks for such a panel,

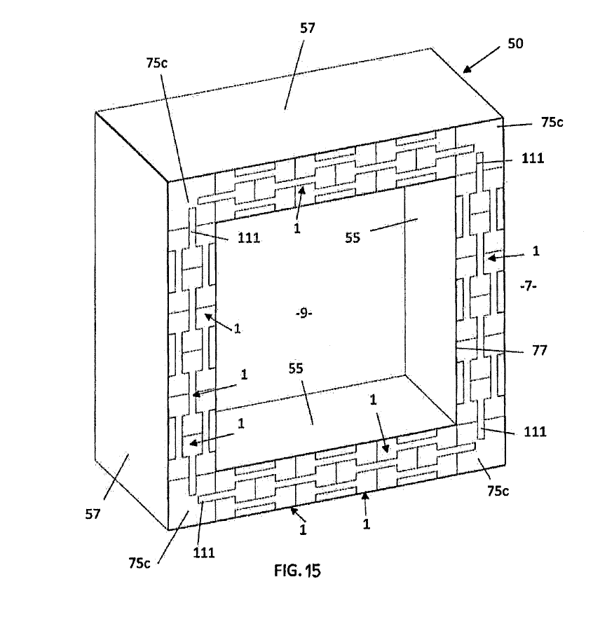

FIG. 15 is an internal view of the assembled housing of FIG. 12,-FIG. 16 is a vertical cross-sectional diagram of a ship hull with a wall provided with the above-mentioned insulating bricks, for example in a chemical product, LNG or LPG transport application, and

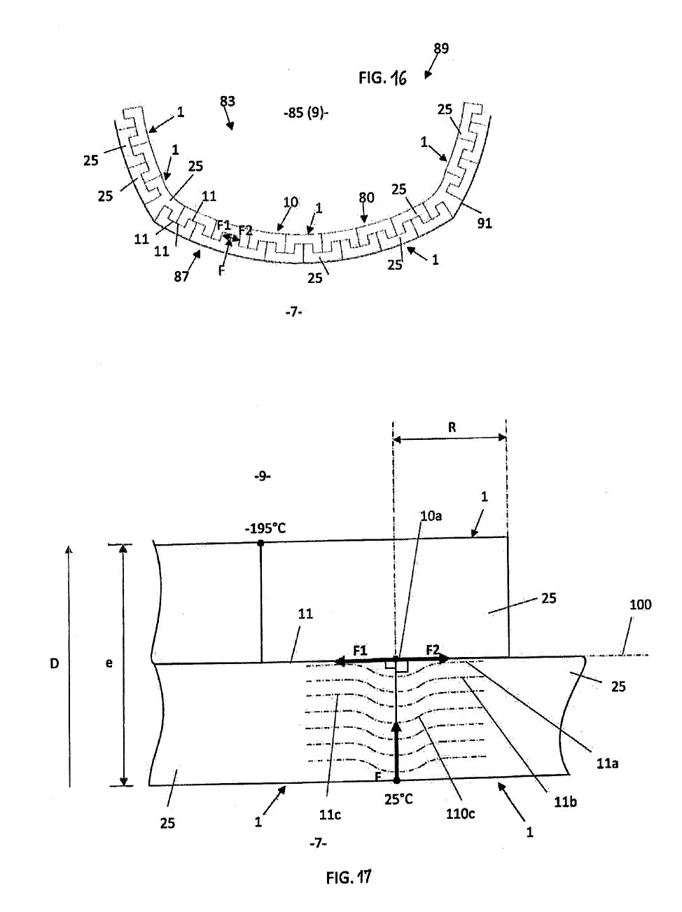

FIG. 17 shows, in greater details, this “change in direction of flow to an isotherm”.

It is specified at this stage that, in this application:
“Part” refers to a part, an element or an elementary brick, whether plane or not (three-dimensional), of any shape.
“transverse” and “transversely” mean oriented transversely, not necessarily perpendicular, to a reference axis or direction, here thickness e and direction D; however, a perpendicularity or angle of less than 30° to this perpendicular is recommended;
“negative pressure” means a pressure that is lower than the ambient pressure (thus <10⁵ Pa).

An objective of this invention is thus to create a part 1 comprising an envelope 3 having at least bends 5 on the outside. Once a succession of such parts have been interposed, as shown in FIG. 6 to 8 or 16, between a first volume 7 and a second volume 9 to be thermally managed relative to the first volume, according to a thickness (e) of the parts 1 and a direction D passing through the first and second volumes (see example FIG. 8), a heat flow F generally provided along the direction to be followed, along the thermal bridges provided between the parts will have to be redirected towards an isotherm 11.

Such an isotherm will typically be provided between two stages of parts 1 (e. g. FIG. 16), or after passing a bend (change of direction on the part(s) 1 concerned) as in a single-stage example shown in FIG. 11.

Thus, as in the examples of FIGS. 6-8, the parts 1 can thus have been arranged, between the volumes 7, 9, each with its thickness parallel to the direction D and so that, transversely to this direction and thickness, the parts 1 are offset two by two transversely from one said layer to the adjacent layer, by being arranged on several layers, such as 13a,13b, along these thickness e and direction D.

The first volume 7 could be the external environment and the second volume 9, an internal volume, in a vehicle.

The layout of parts 1 may be staggered, or half staggered, if there are only two layers, such as 13a,13b in FIG. 9.

An alternative or complementary solution shown in the example in FIG. 10 provides that, relative to thickness e and direction D, the parts 1 should be interlocked at least two by two, transversely (perpendicularly in the example) to said direction and thickness, at the location of the areas marked 15a,15b.

Hence the preferred examples of the above-mentioned illustrated sections of the envelopes 3 and the insulators 25: T-shaped (parts 1a, FIG. 16), or Π-shaped (FIG. 7) or H-shaped (FIG. 9, in particular) or I-(tilted H)-shaped, in a certain direction, a combination of several of these sections or a repetition of at least one of them.

Thus, for example, the H-shaped section (perpendicular to the thickness) of the parts of the embodiment of FIG. 6 can be constructed with two Ts abutting at the free ends of their vertical bars.

If two-by-two offsets between parts 1, transversely to said thickness e and direction D, from one said layer to the adjacent layer are relevant as in the embodiment and the assembling method of FIG. 6 (see sinuous path), interlocking will further increase the effectiveness of the expected thermal management, particularly as regards insulation, and make it possible for the parts to hold and wedge each other.

In this respect, it should be noted that in the invention:
on at least one of the layers, at the longitudinal ends of two adjacent and successive parts of the layer where these two parts each have one said protrusion 21, such that in 15a,15b in FIG. 8, the thermal bridges, such as 16a,16b in FIG. 8, between said two parts of the layer (such as 16a,16b opposite the thermal bridge 16a), are provided:
   throughout the thickness of the protrusions 21,
   facing, on the adjacent layer, a longitudinally intermediate part, such as 23b, a depression 23 of one said part being transversely offset (relative to the direction D and thickness e).

It may even be more preferable that one said protrusion of one said part of a layer should be engaged in a depression of a single said part of the adjacent layer, as is for example the protrusion 21a in the depression 23a defined by the thinner longitudinally intermediate part 23b (thickness e2<e1) of the single-piece part 1b.

And it may be even more preferable that, still at the longitudinal ends of two adjacent and successive parts 1 of a layer, said adjacent protrusions, such as 15b1,15b2 in FIG. 8, of these two parts should be engaged together in one said depression 23c of the longitudinally intermediate part of a single said part 1 of the adjacent layer.

Thus, for example, the local heat flow F in the direction D through the thermal bridge 16c (FIG. 8) will not only be diverted but also blocked over a long length; see F1,F2.

In order to clearly indicate what is here a bent shape 5 of the part 1, such bend have been identified in 50 in different figures. On the envelopes 3, each bend 5 will a priori be defined by a fold of a plate or a sheet, such as a metal sheet. The expression “metal” covers alloys.

It is recommended, depending on said thickness e and direction D:
that the 5, 50 bends should define on each part at least said first zone 21 externally protruding from an externally recessed second zone 23,
and that the parts 1 should be so arranged that at least some of the first zones 21 should be directed towards the second volume 9.

As can be seen in particular in FIGS. 2-4, each thermal insulation part includes an envelope 3 and at least one thermal insulation element 25 which is at 5 least locally surrounded by the envelope.

In fact, the FIGS. 1-6 in particular help, in groups, to visualize that each envelope 3 has two opposite faces defined respectively by these first and second walls 31a,31b, each being in one or more pieces, at least the first wall 31a having at least one said fold 33 defining the corresponding 5, 50 bend; see FIGS. 3, 4 in 10 particular.

To form the or each bend, attaching together, in 45, typically at the location of welds (including brazing), two folded edges 39 of two elementary plates arranged substantially in extension with each other (see in particular FIGS. 1,2) will ensure a fast, reliable, industrial manufacture of the walls 31a, 31b, compatible with a controlled atmosphere setting of the final envelope obtained.

The first and second walls 31a, 31b will be attached together, as marked 37 for example in FIG. 5.

The part 1 (the envelope+the core material 25) will preferably have a thermal conductivity of less than 100 mW/m.K at 20° C. and in an environment under atmospheric pressure.

The first and second walls 31a, 31b can be made from several elementary plates, such as those 43a-43d in FIG. 1, two opposite edges of which are bent in the same direction in 39,

To thermally manage the second volume 9 relative to the first volume 7, according to the thickness (e) of the parts 1 and therefore a direction D passing through these first and second volumes, a thermal insulation system 10 including a series of parts 1 will thus be interposed between these volumes 7 and 9.

This may be better visible in FIGS. 8, 9, which must therefore be considered as horizontal sections that could be made in plane A of FIG. 5, with different embodiments of the parts 1.

Thus, for example, to build a parallelepipedic housing 50 completely surrounding the central volume 7, one or more layers (here three 13a, 13b, 13c) of parts 1 will be arranged on four successive sides, which are in the example interlocked on each of these sides into one system 10. At an angle 51, two adjacent systems 10 are connected by a thermally insulating corner pillar 53 which may also be of the VIP type, such as a metal sheet folded around a thermal insulation element 25 standing as a block and which such an envelope will surround in a watertight manner.

The modularity of the elementary parts 1 will make it possible to easily produce such corner areas d, for example as shown. The two remaining faces, above and below, will be able to receive two, also thermally insulating covers, which could each be formed as one of the above-mentioned faces. Thus, on all sides, on each side, the effect forcing any thermal flow F (globally provided in said local D direction) to at least change direction towards the isotherm 11, between parts 1, will be obtained.

To explain this in greater details, FIG. 17 shows that a thermal flow F has therefore been created:
from an external face (bordering a volume e.g. at 25° C.) of a system of 10 thermal insulation parts 1 assembled edge to edge, as shown,
towards the inner face of said system which borders an inner volume the temperature at −195° C. of which is to be preserved.

It can thus be seen that the flow F circulating in the direction D, along a thermal bridge between two adjacent parts 1 has changed direction (F1/F2) at the transverse interface between such parts, in 10a, where the interface itself has changed direction. On the parts 1 between which the flow F has just seeped, some isotherms 11a, 11b, 11c have been schematized. These are deflected at the axial interface (direction D) such as in 110c for the one marked 11c, because the temperature is warmer there than on both sides, within the insulating parts 1. In 10a, where the flow F is divided into F1/F2, the isotherm 11 is generally transversal to the direction D, since it is located at this transversal interface.

As shown in FIGS. 5 and 9, a system 10 of parts 1 will be favourably placed, for ease of handling, or even metal protection (precaution against piercing of the envelopes 3), between two side plates 55, 57, which may be flat, drawn up in the general plane B perpendicular to A and to said thickness (e) and direction D, if necessary, on each side.

As regards shape, any shape can be made a priori, such as around a tube 59 as shown in FIG. 9 or the elementary parts 1 are curved or bent individually, here in C, in addition to their shape in section, here also in Π (or U), to follow the circumference of the here cylindrical tube 59, having an axis 61. The flows F, from or to the volume 7, will then be substantially radial.

The tube 59 could be closed on one side by a bottom and on the other by a cover, each also provided with a thermal insulator, for example a system 1 made of elementary bricks 10 in the appropriate version, so as to constitute for example a tank which could be cylindrical.

In all the cases considered, the thermal insulation 25 may be a foam or a fibrous material (such as glass or rock wool).

FIGS. 10 to 15 show an exemplary housing 50 or elements belonging thereto and therefore built with parts complying with the invention.

Thus, it is understood with these views that a series of parts 1 assembled in a puzzle as previously explained, those of FIGS. 4-6 in the example, define a generally flat panel 67 having a section 69 (FIG. 11) which presents, on at least two sides (here on its four sides; the figured panel is rectangular), protruding parts 71 of some of said parts 1 to engage each with a matching grooved shape 73 of an end block 75a, 75b or 75c comprising, typically incorporating, at least one thermal insulation element (or material) 76.

On the contrary, the relevant parts 1 of the panel 67 could form grooves and the matching shapes of the end blocks 75a, 75b, 75c could be protruding.

In this case, there is an end block 75a, 75b or 75c facing each side of the section of each panel 67. And at least some of the panels 67, and therefore the end blocks, may not be flat.

In the example of FIG. 11, on two opposite sides (here at the top and bottom), parts 1, with a I- (or tilted H) cross-section, of the central layer 13b protrude, like a tip of variable cross-section, relative to those of the other two layers 13a,13c located on either side. The same is true for the single tongue shape of the two protruding parts 71 on the other two sides (here left and right) formed here by the central core 111 of the I shape of the two central side end parts 1.

As a matter of fact, in the example, the section of these two central side end parts 1 was truncated into a T.

Considering these various shapes, in the example, depending on the parts of the considered sections 69, two types of end blocks 75a,75b are required, with grooves 73.

The end blocks 75a, 75b, 75c, forming thermal insulation like the panels, are used to block the path of the thermal bridges. As a matter of fact, their construction as a unitary block, without any separation for the thermal bridge paths, with bottoms with blocking grooves 73 at which the paths of the panels thermal bridges end up, in the plane of the panels, will reinforce the expected thermal insulation.

FIG. 10 shows the relative locations of the end blocks 75a, 75b, 75c and panels 67 with the respective numbers of 12 and 6, for the parallelepipedic housing shown.

On each end block 75a (FIG. 12) provided between two sides with I- (or tilted H)-shaped protruding parts 71 of the panels 67 arranged transversely, the grooves 73 of the two adjacent longitudinal faces provided therewith are identical and match such I-(or tilted H)-shaped sections of the central layer 13b, at the top and bottom, of parts 1 of the panel 67 concerned.

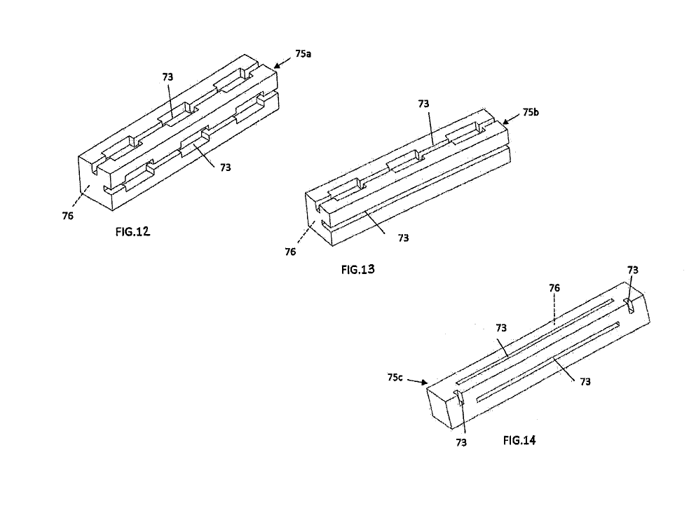

On each end block 75c (FIG. 14) provided between two central core 111 sides of transversely arranged 67 panels, the grooves 73 of the two adjacent longitudinal faces provided therewith are identical and match these central cores 111 of the relevant central layers 13b.

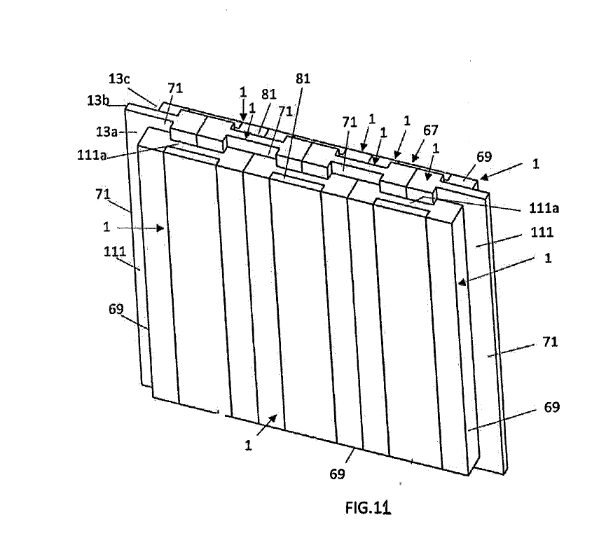

On each hybrid end block 75b (FIG. 13), between the end blocks 75a, 75c, provided between a central core 111 side and a side with I- (or tilted H)-shaped protruding parts of the panel 67 transverse to the previous one, the grooves 73 of the two adjacent longitudinal faces provided therewith are identical and match these central cores 111 and I- (or tilted H)-shaped protruding parts 71, respectively.

Thus, the end blocks 75a, 75b, 75c form multi-part frames that frame the whole section of each panel 67, while connecting and maintaining them together in the corners of the housing 50, see in particular FIG. 15.

With a parallelepipedic cross-section, these end blocks may each have, on the two other sides, solid walls suitable for supporting the side plates 55, 57 internally and externally. Each panel 67 can thus be pressed between these two side walls attached to the end blocks.

Fastening with a layer of glue 77 or screws, for example, is possible.

An application for all or part of the elementary brick 1 insulating systems 10 presented above may concern a limitation wall 80 of a tank 83 containing a chemical product 85 to be maintained at a certain temperature and/or pressure, for example LNG to be maintained at about −190° C. during transoceanic transport, or LPG (FIG. 16).

The second volume 9 to be thermally managed is then that of the tank 83 and a first volume 7 can be water, such as sea water.

The wall 80 is provided with a system 10 according to at least one of the types conforming to the solution presented above and here, in other words, with a series of said parts 1 with insulation 25.

The system 10 includes in the example several layers of such parts, here a combination of interlocking parts (T-and Π-shaped) which, via bends, block the flow F by changing direction F1/F2, as already explained.

The wall 80 can integrate, contain or be lined by the system 10.

As in the example, the tank limitation wall 80 can define a bulkhead between two compartments, or define or belong to all or part of a hull 87 of a boat 89.

The boat 89 can be a ship and therefore intended for maritime navigation.

Using such a solution with elementary bricks 1 will make it possible to follow the arched shape of the hull.

Providing the base wall 91 of the boat 89, on the concave side, with one or more system(s) 10 will make it possible to follow the curved shape of the hull inside, while ensuring the expected thermal management performance.

Inside, these system(s) 10 can be lined with at least one wall compatible with the product 85 contained.

Another application could be the construction of an insulating box around a liquefied gas production chamber, with for example an internal volume 9 at −196° C. to be thermally managed and an external environment 7 at the atmospheric temperature of the place, therefore between −30 and 45° C.

It should also be noted that in connection with the targeted modular construction, yet another problem was taken into account, namely size and weight.

Thus, it is rather recommended that, in the “redirected” direction of the flows F1/F2 from the initial flow F (as in the direction of FIG. 17), there is a transverse overlap R of a part 1 by the adjacent part (see FIGS. 10, 11, 24, in the direction 100 of FIG. 17) less than or equal to 500 mm, with parts (1, 1a, 1b) therefore containing thermal insulation.

The overall thickness e should preferably be less than 300 mm.

The elementary surface area of each room 1 should preferably be less than or equal to 2.5 m^{2.}

The wall of the envelope 3 of each part 1 should preferably be made of stainless steel (or other lighter metal or alloy) less than 1.2 mm.

1. A thermal insulation system comprising a series of thermal insulation parts providing, at least for some of them, thermal bridges between them and which are:
arranged in several layers according to a thickness that each part has and which varies according to a length:
that said part has transversely to said thickness, and
along which each said part thus includes at least one protrusion externally adjacent to a depression,
offset and interlocked two by two transversely, from one said layer to an adjacent layer of said layers, so that one said part protrusion of one said layer is engaged in one said part depression of the adjacent layer, thereby forcing a heat flow, generally provided according to the thickness, along the thermal bridges, to change direction towards an isotherm and then to be blocked by a local orientation substantially in an opposite direction,
wherein:
said system is to be interposed between a first volume and a second volume to be thermally managed relative to the first volume,
said layers are arranged in a direction passing through the first and second volumes, with the thicknesses and length(s) being defined respectively in said direction and transversely thereto,
on at least a first of said layers, at longitudinal ends of two of said adjacent and longitudinally successive parts of said first layer where said two parts each have one said protrusion, said thermal bridges between said two parts of said first layer are provided:
throughout the thickness of the protrusions, and,
facing, on a second, adjacent, layer, in the thickness wise direction, of an intermediate longitudinal portion of one said depression of one said part which is offset transversely with respect to said two longitudinally, adjacent and successive parts of the first layer.

2. A system according to claim 1, wherein one said protrusion of one said part of a layer is engaged in one said depression of a single said part of the adjacent layer,

3. A system according to claim 1, wherein the thermal insulation parts are individually internally under controlled atmosphere.

4. A system according to claim 1, wherein at least some of the thermal insulation parts comprise an envelope and at least one thermal insulation element which the envelope surrounds at least locally, with the envelope and said element each having at least one bend on the outside and according to said thickness and direction, said bends define on each part at least one said protrusion relative to one said depression.

5. A system according to claim 1:
wherein said series of parts defines a panel having a section which has, on at least two sides, protrusions or depressions of some of said parts, and
which comprises an end block comprising at least one thermal insulation element and grooved or protruding parts engaged, in matching male-female shapes, with said protrusions or depressions of said parts.

6. A system according to claim 5 which is presented as a housing having side walls and a bottom, each comprising at least one said panel engaged, on its edge, with said end blocks, some of which are common to the side walls and the bottom.

7. A system according to claim 5, where the or each panel is pressed between two side plates attached to the end blocks.

8. A system according to claim 1, wherein, in said changed direction of the flow, a part transversely covers an adjacent part on a distance of 500 mm or less, and/or the elementary surface area of each said part is 2.5 m² or less.

9. A system according to claim 1, wherein said parts individually comprise an envelope and at least one thermal insulation element that the envelope surrounds at least locally, with the envelope and the thermal insulation element each having externally several bends defining said protrusions adjacent to said depressions.

10. A system according to claim 9, the envelope and said at least one thermal insulation element of which have a T-, or Π- or H- or I-shaped section or, in a direction, a combination of several of these sections or a repetition of at least one of them.

11. A double system, each according to claim 1, with each system being arranged transversely one to the other, said systems being, adjacent to each other in at least one corner, with, in that corner, the two systems which are connected by an insulating corner pillar.

12. A double system according to claim 11, wherein the insulating corner pillar is formed by one said end block.

13. A wall for limiting a tank containing a chemical product to be maintained at a certain temperature and/or pressure, with the wall being provided with a system according to claim 1.

14. A boat comprising a hull provided with the tank limitation wall according to claim 11.

15. A thermal insulation housing comprising said parts of several said assembled systems, each according to claim 1.

16. A vehicle in which the system is arranged according to claim 1.
